(19) United States
(12) Patent Application Publication
(10) Pub. No.: US 2012/0086391 A1
(43) Pub. Date: Apr. 12, 2012

(54) Recharging device for use with electronic stylus pen's

(76) Inventor: Anne Marie Renee Smith, Spring Hill, FL (US)

(21) Appl. No.: 13/200,586

(22) Filed: Sep. 26, 2011

Related U.S. Application Data
(60) Provisional application No. 61/404,096, filed on Sep. 27, 2010.

(51) Int. Cl. H02J 7/00

(52) U.S. Cl. 320/107; 320/137

(57) ABSTRACT

The invention provides an electronic stylus pen charging system for an interactive whiteboard with electronic stylus pen. The electronic stylus pen charging system uses a set of magnets and charging circuitry to charge the battery of the electronic stylus pen.

### CROSS-REFERENCE TO RELATED APPLICATIONS

This application claims the benefit of the filing date of U.S. Provisional Patent Application No. 61/404,096 filed Sep. 27, 2010.

### FEDERALLY SPONSORED RESEARCH

Not Applicable

### SEQUENCE LISTING OR PROGRAM

Not Applicable

### BACKGROUND OF THE INVENTION

1. Field of Invention

The embodiments of the invention relate to interactive whiteboards with an electronic stylus pen. The embodiments of the invention further relate to the field of charging the electronic stylus pen associated with the interactive whiteboard. More specifically, this invention relates to a charging device having a mechanism for charging an electronic stylus pen.

2. Background of the Invention

Interactive whiteboards with an electronic stylus pen are being used by more and more people. Many users share these interactive whiteboards with an electronic stylus pen. When sharing the device between users, the electronic stylus pen must be charged and ready for use before it can be used. When sharing the device between users the use of the electronic stylus pen and/or interactive whiteboard can be limited due to the required charging time of the electronic stylus pen. Multiple electronic stylus pens can be purchased however the electronic stylus pens' are unusable until charged with the interactive whiteboard. Users who share these interactive whiteboards do not always have access to the interactive whiteboard in order to charge their electronic stylus pen rendering their interactive whiteboard electronic stylus pen unusable until the electronic stylus pen is charged. Also, the interactive whiteboard with electronic stylus pen must have access to power in order to charge the electronic stylus pen. Some users mount their interactive whiteboard with electronic stylus pen where there is no access to power. This then requires the user to remove the interactive whiteboard with electronic stylus pen in order to charge their electronic stylus pen and then remount their interactive whiteboard with electronic stylus pen. Removal and remounting of the interactive whiteboard with electronic stylus pen for charging can be cumbersome to users, and it reduces usage time of the device, and increases the chance of damage to the interactive whiteboard with electronic stylus pen.

### SUMMARY

In accordance with one embodiment of the present invention a charging system for an interactive whiteboard's electronic stylus pen is provided. In this embodiment, the charging system includes a charging mechanism, and a cradle or retention mechanism. The charging system charges the batteries of the electronic stylus pen through the metal contacts located on the electronic stylus pen that make contact with the magnets located in the cradle. The magnets extend through the top of the cradle case to enable direct contact between the metal contacts of the electronic stylus pen and the magnets in the cradle. The user places the electronic stylus pen in the receiving slot on the top of the cradle. By placing the electronic stylus pen in the receiving slot, the metal contacts are then secured into place by the magnetic pull of the magnets in the cradle. Once the electronic stylus pen is securely in place, the electronic stylus pen can begin charging. The magnets in the cradle charge the electronic stylus pen with 5V DC power. That power is received from an external computer. This is achieved when a user connects the cradle to a computer with an external USB cable, where one end of the cable is plugged into the computer and the other end is plugged into the micro USB port of the cradle. The cradle then receives power from the computer through the micro USB port on the cradle and that power is then routed through the internal PCBA (printed circuit board assembly) to all the parts of the cradle. The cradle will then turn on. Once turned on, the LED light on the cradle will turn on to indicate that the cradle is powered on. The magnets will then receive power. The electronic stylus pen will then begin charging automatically. Once the cradle is powered on, the user can charge their electronic stylus pen.

The cradle in this embodiment also includes a six port USB 2.0 hub with an integrated HC SD card reader. The user can transfer data between the computer and the six USB 2.0 ports and the HC SD Card reader through the micro USB port independently of the charging capabilities of the cradle. The user has the ability to place the cradle horizontally on any flat surface. The magnets and anti-skid tape on the bottom of the cradle give the user another option for placement of the cradle vertically on any flat metal surface. The magnets and anti-skid tape help secure the device to the metal surface. Once the user disconnects the external USB cable from the cradle, it is then powered off. The LED light also turns off indicating to the user that the cradle is now powered off.

Other systems, methods, features, and advantages will be or become apparent to one with ordinary skills in the art upon examination of the following drawings and detailed description.

### BRIEF DESCRIPTION OF THE DRAWINGS

FIG. 1 is a perspective view of a charging system in accordance with an embodiment of the present invention.

FIG. 2 is an exploded view of a recharging system in accordance with an embodiment of the present invention.

FIG. 3 is a perspective view of a charging system in accordance with an embodiment of the present invention, and an electronic stylus pen, USB cable, SD card, and computer.

FIG. 4 is a perspective view of an internal printed circuit board assembly.

FIG. 5 is a top view of a charging system in accordance with an embodiment of the present invention.

FIG. 6 is a bottom view of a charging system in accordance with an embodiment of the present invention.

FIG. 7 is a front view of a charging system in accordance with an embodiment of the present invention.

FIG. 8 is a back view of a charging system in accordance with an embodiment of the present invention.

FIG. 9 is a right side view of a charging system in accordance with an embodiment of the present invention.

FIG. 10 is a left side view of a charging system in accordance with an embodiment of the present invention.

### DETAILED DESCRIPTION

The aspects, features and advantages of the present invention will be appreciated when considered with reference to the following description of preferred embodiments and accompanying figures. In describing the preferred embodiments of the invention illustrated in the figures, specific terminology will be used for the sake of clarity. However, the invention is not intended to be limited to the specific terms so selected, and it is to be understood that each term selected includes all technical equivalents that operate in a similar manner to accomplish a similar purpose.

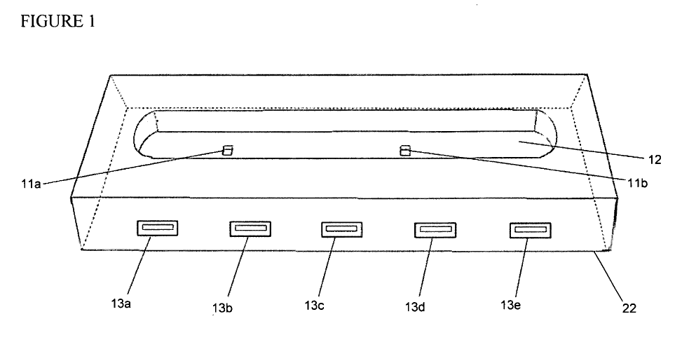

FIG. 1 illustrates a perspective front-angle view of the charging cradle device 22 for charging an electronic stylus pen 26. As shown in FIG. 1, the charging cradle device 22 includes the front USB ports 13a,13b,13c,13d,13e. The USB ports 13a, 13b,13c,13d,13e may be varying types, varying amounts, changed locations, be spaced at different intervals or be removed. The receiving slot 12 for the electronic stylus pen 26 is on the top of the charging cradle device 22. The magnets 11a,11b protrude through the top of the charging cradle device 22 in order to make contact with the metal contacts on the electronic stylus pen 26. While FIG. 1 shows the charging cradle device 22 having a specific size, receiving slot 12, location of charging magnets 11a,11b, and shape, it should be understood that the charging cradle device 22 is not limited to this particular size, receiving slot 12, location of charging magnets 11a,11b, or shape and may instead be of any material, configuration and design such that it can enable charging of an electronic stylus pen 26.

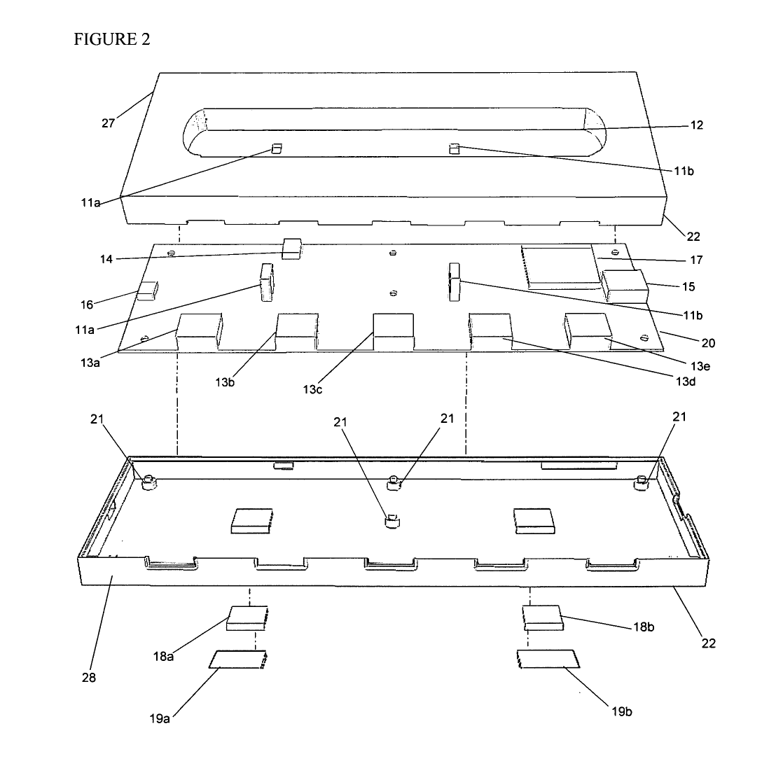

FIG. 2 illustrates an exploded view of the charging cradle device 22. The top of the charging cradle device 27 connects to the bottom of the charging cradle device 28 with the PCBA (printed circuit board assembly) 20 inside the charging cradle device 22. The PCBA board 20 rests on the stand offs 21 on the inside bottom of the charging cradle device 28. Varying methods to place or secure the PCBA 20 inside the charging cradle device 22 can be employed. The PCBA 20 has the front USB ports 13a,13b,13c,13d,13e; the side USB port 15; the micro USB port 16; the HC SD Reader 17: the LED light 14; and the magnets 11a,11b. The USB ports 13a,13b,13c,13d,13e; the side USB port 15; the micro USB port 16; the HC SD Reader 17: and the LED light 14 can be of varying types, or amounts, be spaced at different intervals or locations or any or all can be removed. Two magnets 18a,18b, used to help secure the charging cradle device 22 to a magnetic metal surface, attach to the outside bottom of the device 22 with anti-skid tape 19a,19b, covering those magnets 18a,18b. The magnets 18a,18b can be located inside or other various locations, they can be increased or decreased in number, they can be varying sizes, shapes, material, magnetic pull, or thicknesses or they can be removed from the charging cradle device 22. The anti-skid tape 19a,19b, used to help prevent slippage of the charging cradle device 22, can be of varying sizes, types, shapes, consistencies, materials, tensile strengths, adhesiveness, temperature use ranges, backings, physical properties, thicknesses, amounts, locations, etc. or can be removed from the charging cradle device 22.

Thus, in one alternative embodiment, the anti-skid tape 19a,19b could be replaced with any form of anti-skid material.

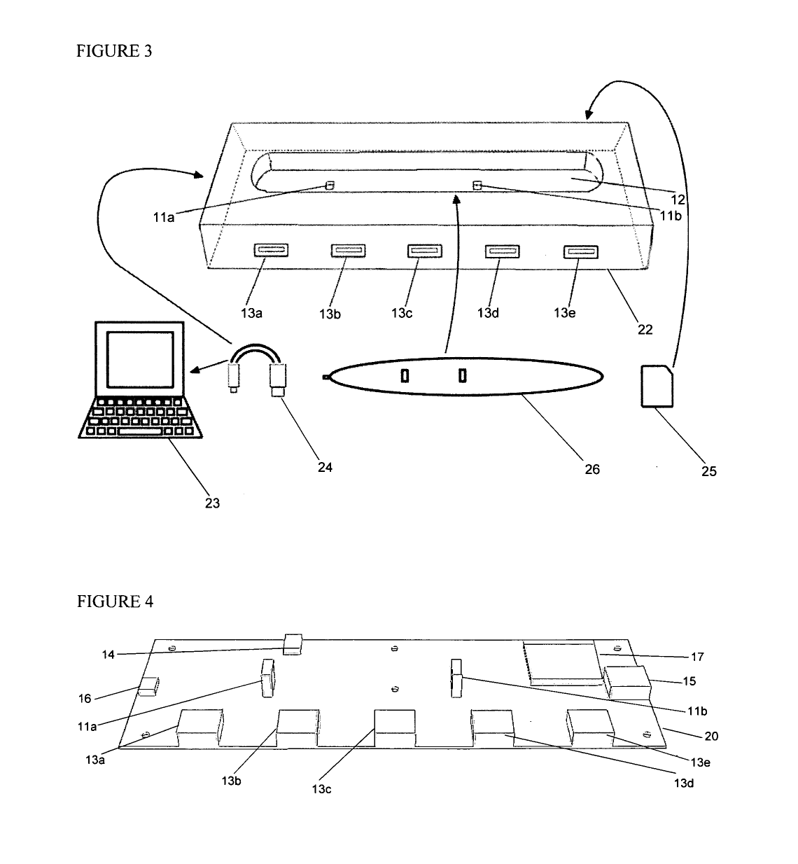

FIG. 3 shows the PCBA board 20 that sits inside the charging cradle device 22. The magnets 11a,11b; the front USB ports 13a,13b,13c,13d,13e; the side USB port 15; the HC SD card reader 17; and the LED light 14 will be powered through the PCBA board 20 which receives power from an external computer 23 (shown in FIG. 4) through the micro USB port 16. Alternately, the charging cradle device 22 may have varying types of an LED light 14. The LED light 14 can be different colors or shapes or replaced by laser diodes, OLED's, passive-matrix or active-matrix liquid crystal displays, or other electric lighting sources. The LED light 14 can be removed or additional LED lights can be added or replaced or added to by various color or shape laser diodes, OLED's, passive-matrix or active-matrix liquid crystal displays, or other electric lighting sources. The placement of the LED light 14 or the placement of additional LED lights or laser diodes, OLED's, passive-matrix or active-matrix liquid crystal displays, or other electric lighting sources can be moved to various places on or in the device. The LED light 14 can be replaced with various indicator mechanisms or can be removed.

Thus, in one alternative embodiment, various selecting or indicating mechanisms for various functions can be added to the charging cradle device 22. The selecting mechanism can be any kind of selecting mechanism, including a mechanical selector such as a switch, toggle, dial, jog shuttle or slide button. Alternatively, the selecting mechanism may be an electronic selector such as a programmable “soft button” or “soft key” that may be interoperable with a user interface of the charging cradle device 22.

FIG. 4 shows the device 22 and the items that will work with the device 22. The illustrated electronic stylus pen 26 makes contact with the magnets 11a,11b for charging of the electronic stylus pen 26. The micro USB port 16 will get power through an external USB cable 24 that will be connected to an external computer 23. Alternately, differing power capabilities can be added to or take the place of the existing power input to the charging cradle device 22 such as AC power, or batteries for internal or external power. The SD card 25 will be placed into the HC SD card reader 17 and transfer data to and from the external computer 23 through the USB cable 24 connected to the micro USB port 16. Alternately, A USB cable can be incorporated in the device instead of or in addition to or in place of the USB ports in the device.

Thus, in one alternative embodiment, wireless capabilities can be added to the charging cradle device 22 for data transfer.

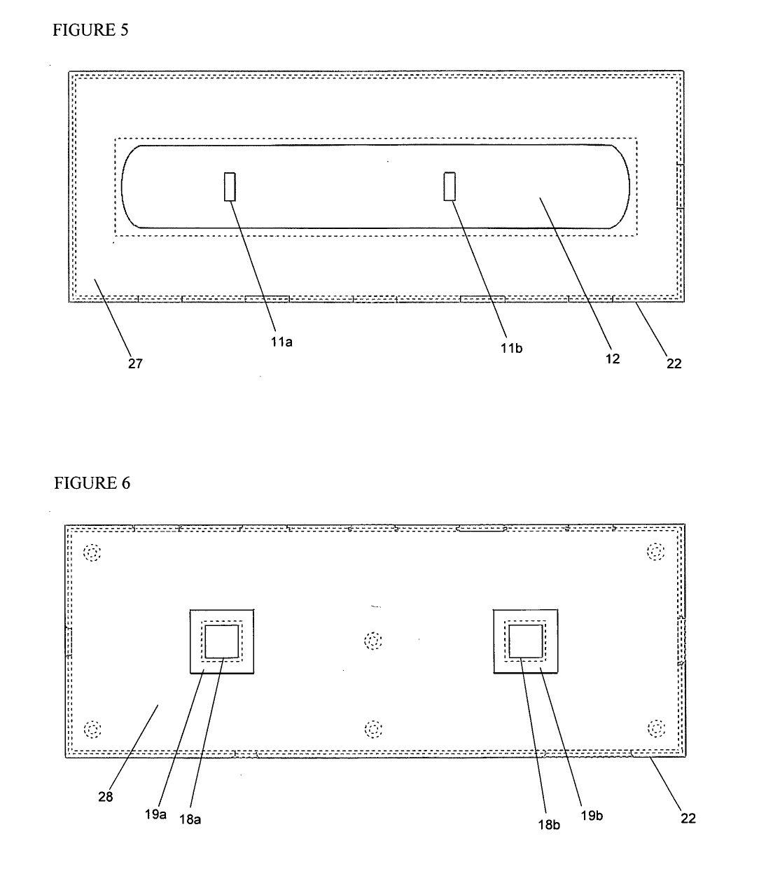

FIG. 5 shows the top 27 view of the charging cradle device 22. It shows the receiving slot 12 for the electronic stylus pen 26 and the magnets 11a,11b that make contact with the electronic stylus pen 26. The magnets 11a,11b on the PCBA board 20 that make contact with the electronic stylus pen 26 can be different materials, heights, sizes, magnetic pull, or thicknesses, lengths, depths, widths or shapes.

Thus, in one alternative embodiment, a cover for the charging cradle device 22 of various materials, shapes, attachment techniques, sizes, or colors can be added to the charging cradle device 22.

FIG. 6 shows the bottom view of the charging cradle device 22. It shows the magnets 18a,18b and the anti-skid tape 19a,19b that cover the magnets 18a,18b.

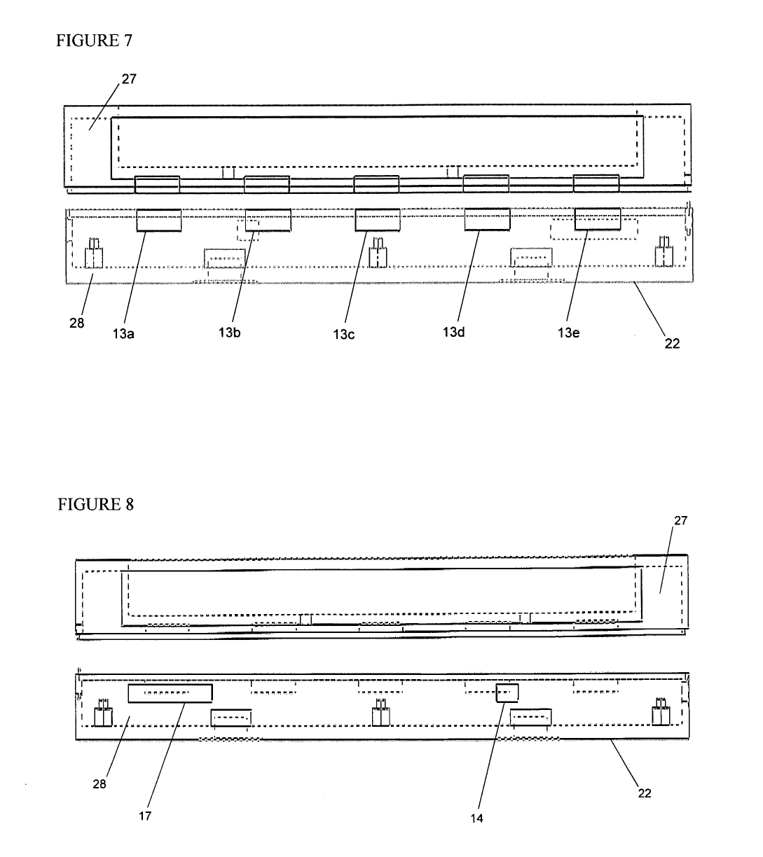

FIG. 7 shows the front view of the charging cradle device 22. It is shows the top 27 and bottom 28 of the charging cradle device 22. It also shows where the front USB ports 13a,13b,13c,13d,13e are placed.

FIG. 8 shows the back view of the charging cradle device 22. It shows the top 27 and the bottom 28 of the charging cradle device 22. It also shows where the HC SD card reader 17 and the LED light 14 are placed.

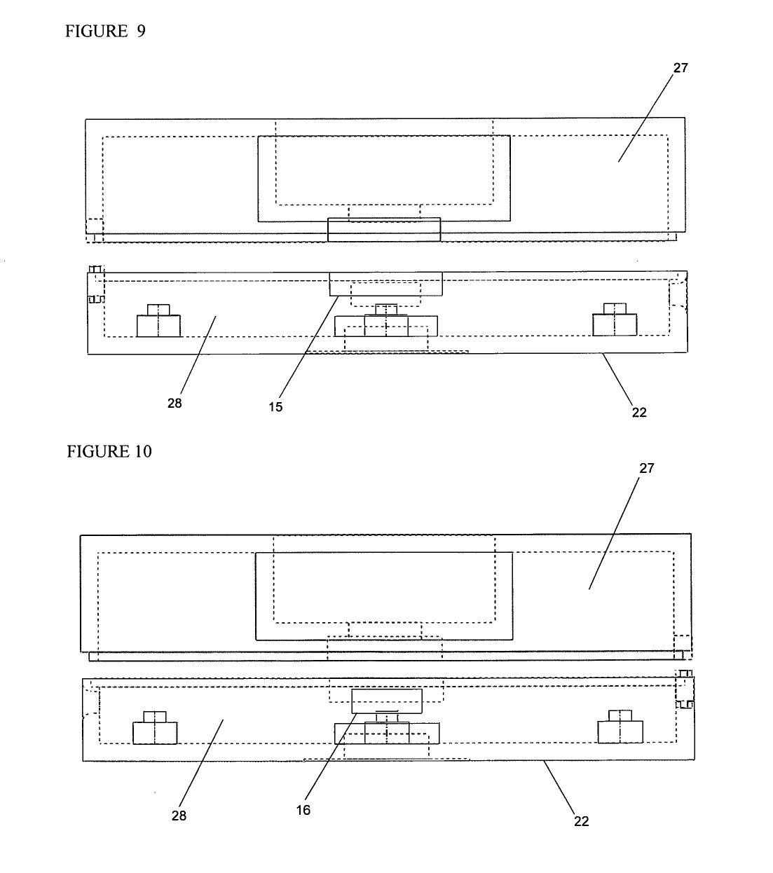

FIG. 9 shows the right view of the charging cradle device 22. It shows the top 27 and the bottom 28 of the charging cradle device 22. It also shows where the side USB port 15 is placed.

FIG. 10 shows the left view of the charging cradle device 22. It shows the top 27 and the bottom 28 of the charging cradle device 22. It also shows where the micro USB port 16 is placed.

Although the invention herein has been described with reference to particular embodiments, it is to be understood that these embodiments are merely illustrative of the principles and applications of the present invention. It is therefore to be understood that modifications or changes may be made to the illustrative embodiments and that other arrangements may be devised without departing from the spirit and scope of the present invention.

1. A method for charging an electronic stylus pen of an interactive whiteboard device, the method comprising:
Connecting the metal contacts of the electronic stylus pen to the magnets of the charging system, and thereby charging the battery of the electronic stylus pen.
Whereby, a user can charge their electronic stylus pen independently of their interactive whiteboard.

2. A charging system for an electronic stylus pen, comprising: a set of magnets and charging circuitry configured to charge the battery of the electronic stylus pen when the metal contacts of the electronic stylus pen connect with the magnets of the charging system.
Whereby, a user can charge their electronic stylus pen independently of their interactive whiteboard.
